(19) United States
(12) Patent Application Publication
(10) Pub. No.: US 2015/0129126 A1
(43) Pub. Date: May 14, 2015

(54) BONDING METHOD AND BONDING TOOL, AND METHOD FOR PRODUCING STRUCTURAL BODY

(71) Applicant: MITSUBISHI HEAVY INDUSTRIES, LTD., Tokyo (JP)

(72) Inventors: Nozomi Saito, Tokyo (JP); Takashi Yari, Tokyo (JP)

(21) Appl. No.: 14/399,577

(22) PCT Filed: May 31, 2013
(86) PCT No.: PCT/JP2013/065148

§ 371 Date: Nov. 7, 2014

(30) Foreign Application Priority Data
Jun. 25, 2012 (JP) 2012-141981

(51) Int. Cl. G02B 6/46

(52) U.S. Cl. CPC G02B 6/46
USPC 156/307.7; 156/499

(57) ABSTRACT

A bonding method and a bonding tool that enable quick and reliable bonding of an optical fiber to a structural body by a simple process, and a method for producing a structural body are provided. In an optical fiber (1), a strand is coated with a coating portion of a thermoplastic resin. At least one portion of the coating portion is heated and melted by a heater (14). The portion where the thermoplastic resin is melted of the optical fiber (1) and a surface of a structural body (17) are brought into contact with each other in a state in which the thermoplastic resin is melted. A molding roller (15) pressure-bonds the optical fiber (1) to the surface of the structural body (17) . The thermoplastic, resin is then cooled and cured, so that the optical fiber (1) is bonded to the structural body (17).

### TECHNICAL FIELD

The present invention relates to a method for bonding an optical fiber to a surface of a structural body such as an aircraft and a wind blade, and a bonding tool used for bonding an optical fiber, and a method for producing a structural body.

### BACKGROUND ART

In soundness evaluation of a structural body using an optical fiber, an optical fiber is bonded and attached to a surface of a structural body. A strain generated in the structural body is transmitted to the optical fiber, and the strain generated in the optical fiber is measured, so that damage to the structural body is detected. For example, in a structural body obtained by bonding members, separation in a bonded portion, of the structural body is detected by measuring a strain generated in an optical fiber. Examples of the structural body include an aircraft, an automobile, and a wind blade.

As described in PTL 1 and PTL 2, in the optical fiber used for a sensor, a resin coating is formed on an outer periphery of a strand having a core and a clad. To surely transmit a strain generated in the structural body to the optical fiber, the optical fiber is generally bonded to the structural body by a chemically reactive adhesive such as an epoxy-based adhesive.

The optical fiber is bonded to the structural body by using a chemically reactive adhesive in a following process.

First, an adhesive obtained by mixing a primary agent and a curing agent is applied to a predetermined position on a surface of the structural body. Subsequently, the optical fiber is placed at a predetermined position on the adhesive. The adhesive is further applied onto the optical fiber. At this point, the optical fiber is coated with the adhesive as shown in a sectional view in Fig. 3. After that, the adhesive is left to be cured,

### CITATION LIST

### Patent Literature

{PTL 1}

Japanese Unexamined Patent Application, Publication No. Hei7-151945

{PTL 2}

Japanese Unexamined Patent Application, Publication No. 2004-151702

### SUMMARY OF INVENTION

### Technical Problem

In the aforementioned soundness evaluation using the optical fiber, in order to surely transmit the strain in the structural body to the optical fiber, it is necessary to bond the optical fiber so as to prevent disengagement from the structural body. Therefore, the adhesive needs to be applied so as to completely coat the optical fiber when viewed in a section as shown in FIG. 3. Also, in the above general bonding process, if takes about one day until the adhesive is completely cured since the chemically reactive adhesive is used. It is necessary to hold the optical fiber so as to prevent displacement before the adhesive is cured.

As described above, there is a problem that, work efficiency is poor since the. work process requires great, care to ensure high bonding position accuracy, and it takes a long time until completion of the work.

The present invention has been made in view of the above problem, and an object thereof is to provide a bonding method that, enables quick and reliable bonding of an optical fiber to a structural body by a simple process, and a bonding tool that achieves the method. Another object of the present invention is to provide a method for producing a structural body to which an optical fiber is bonded by a simple process,

### Solution to Problem

To achieve the above object, a first aspect of the present invention is a bonding method for bonding an optical fiber in which a strand is coated with a thermoplastic resin to a surface of a structural body, including the steps of: melting at least one portion of the thermoplastic resin; bringing the portion where the thermoplastic resin is melted of the optical fiber and the surface into contact with each other in a state in which the thermoplastic resin is melted; pressure-bonding the optical fiber to the surface; and cooling and curing the thermoplastic resin.

A second aspect of the present invention is a bonding tool including: an optical fiber feeding section that feeds an optical fiber in which a strand is coated with a thermoplastic resin to a surface of a structural body; a heater that melts at least one portion of the thermoplastic resin; and a pressure-bonding section that brings the portion where the thermoplastic resin is melted and the surface into contact with each other, and pressure-bonds the optical fiber to the surface,

A third aspect of the present invention is a method for producing a structural body to which an optical fiber in which a strand is coated with a thermoplastic resin is bonded, including the steps of: melting at least one portion of the thermoplastic resin; bringing the portion where the thermoplastic resin is melted of the optical fiber and a surface of the structural body into contact with each other in a state in which the thermoplastic resin, is melted; pressure-bonding the optical fiber to the surface; and cooling and curing the thermoplastic resin.

In the present, invention, the thermoplastic resin that coats the strand is used as an adhesive. By using the bonding method and a bonding jig of the present invention, it takes only one minute or less from pressure-bonding of the optical fiber to the surface of the structural body to curing. Therefore, a time required for the work is considerably reduced as compared to a conventional method using a chemically reactive adhesive. It is also possible to prevent displacement of the optical fiber before the thermoplastic resin is completely solidified.

Also, by using the method and line bonding tool of the present invention, the optical fiber can be bonded to the structural body in a state in which the strand, is coated with the thermoplastic resin. Therefore, the thermoplastic resin allows a strain in the structural body to be transmitted to the optical fiber, so that soundness evaluation can be performed with high accuracy.

### Advantageous Effects of Invention

Since the time to curing of the resin can be considerably reduced by the bonding method of the present invention as compared to a conventional bonding process, workability is improved. Since it is also possible to bond the optical fiber without displacing the optical fiber from a predetermined position or disengaging the optical fiber from the structural body, the accuracy of the soundness evaluation using the optical fiber sensor can be improved.

Since the optical fiber feeding section, the heater, and the pressure-bonding section are integrated, the bonding tool of the present invention is easily handled. Also, by using the bonding tool of the present invention, the optical fiber can be bonded to a predetermined position with good position accuracy.

### BRIEF DESCRIPTION OF DRAWINGS

FIG. 1 is a schematic view of an optical fiber bonded to a surface of a structural body by a method of the present invention.

FIG. 2 is a schematic view tor explaining a bonding jig and a bonding method of the present invention.

FIG. 3 is a sectional view of a structural body to which an optical fiber is bonded by a conventional method.

### DESCRIPTION OF EMBODIMENTS

### First Embodiment

In the following, a bonding method, a bonding jig, and a method for producing a structural body according to a first embodiment are described.

FIG. 1 is a schematic view of an optical fiber applied to the bonding method of the present embodiment. An optical fiber 1 includes a strand 2 having a core and a clad, and a coating portion 3 that coats an outer periphery of the strand 2. In the present embodiment, an optical fiber having a configuration in which another coating portion (polyimide or the like) is provided between the strand 2 and the coating portion 3 may be also employed.

In the present embodiment, materials of the core and the clad are not particularly limited, h diameter of the strand 2 is 0.05 to 0.15 mm.

The coating portion 3 applicable to the bonding method of the present embodiment is formed of a thermoplastic resin. Examples of the thermoplastic resin include polyester-based, styrene-based, and polyethylene-based resins. A thickness of the coating portion 3 is 0.1 to 0.5 mm.

An object to which the optical fiber 1 in FIG. 1 is to be bonded is a structural body such as an aircraft, an automobile, and a wind, blade. The structural body is a member of a fiber reinforced resin substrate such as a carbon fiber reinforced resin substrate and a glass fiber reinforced resin substrate, or a metal plate such as aluminum. Also, members made of the above material may be attached together by an adhesive. For example, an epoxy-based adhesive may be applied, as the adhesive.

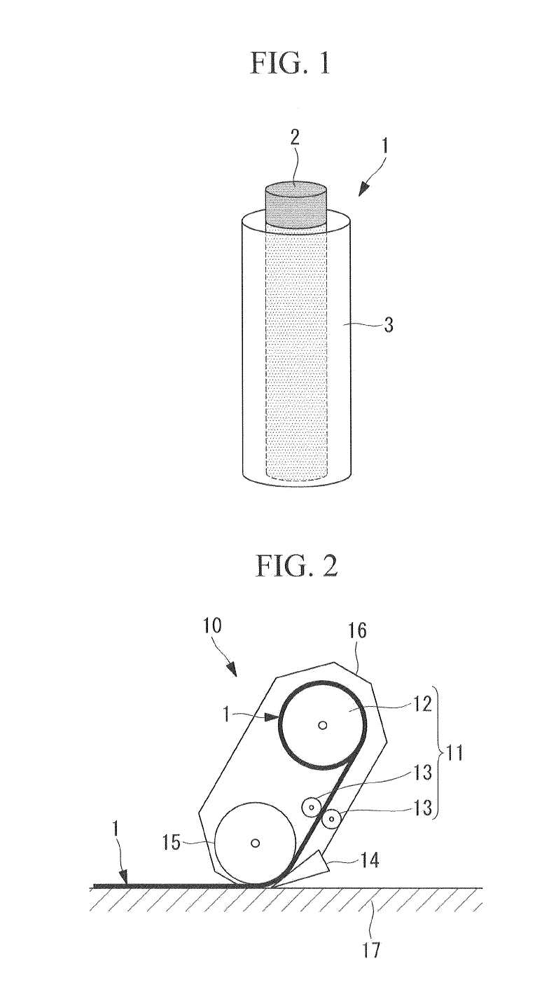

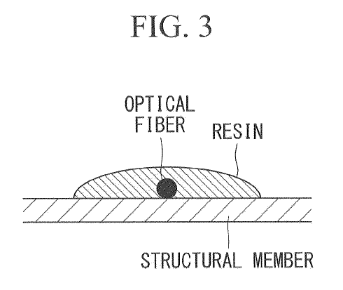

FIG. 2 is a schematic view for explaining the bonding jig of the present embodiment.

In a bonding jig 10, an optical fiber feeding section 11, a heater 14, and a molding roller (pressure-bonding section) 15 are accommodated in a casing 16.

The optical fiber feeding section 11 includes an optical fiber winding roller 12, and two optical fiber feeding rollers 13, The optical fiber 1 is wound around the optical fiber winding roller 12. Note that the number of the optical fiber feeding rollers 13 may be one.

The heater 14 is mounted in an optical fiber unwinding direction with respect to the optical fiber feeding section 11. The molding roller 15 is mounted in the optical fiber unwinding direction with respect to the heater 14. The heater 14 is preferably mounted close to the molding roller 15 such that a surface of a structural body 17 and the optical fiber 1 can come into contact with each other before the heated thermoplastic resin is cooled and cured.

The heater 14 is preferably a device that feeds hot air toward the optical fiber (e.g., a dryer). A heater temperature adjusting means (not shown) that adjusts a temperature of the hot air fed from the heater 14 is connected to the heater 14.

In the bonding tool 10, the heater 14 is mounted on an opposite side from the molding roller 15 with respect to the optical fiber 1. That is, the heater 14 can heat a surface of the optical fiber 1 opposite to a surface in contact with the molding roller 15.

The optical fiber 1 unwound from the optical fiber winding roller 12 passes between the optical fiber feeding rollers 13, and is inserted between the molding roller 15 and the structural body 17. The molding roller 15 presses the optical fiber 1 against the surface of the structural body 17.

The bonding jig 10 can move along the surface of the structural body 17 with the molding roller 15 rotating.

A process of bonding the optical fiber to the surface of the structural body by use of the bonding jig 10 is described below.

The bonding jig 10 is mounted at a starting point of a position to mount the optical fiber on the surface of the structural body 17. The optical fiber mounting position is close to a bonding surface of two members in the structural body 17.

At this point, an end portion of the optical fiber 1 unwound from the optical fiber winding roller 12 is inserted between the molding roller 15 and the structural body 17.

Subsequently, the bonding jig 10 is moved along the surface of the structural body 17 so as to follow an optical fiber mounting planned position. In FIG. 2, the bonding jig 10 is moved in a right direction of the paper face.

Along with the movement of the bonding jig 10, the optical fiber winding roller 12, the optical fiber feeding rollers 13, and the molding roller 15 are rotated. Accordingly, the optical fiber 1 is unwound from the optical fiber winding roller 12, and conveyed to the heater 14 and the molding roller 15 through the optical fiber feeding rollers 13.

The heater 14 heats and melts the thermoplastic resin that coats the surface of the optical fiber 1. Any heating temperature may be employed as long as the thermoplastic resin can be melted. The heating temperature is appropriately set according to the type of the thermoplastic, resin. In the present embodiment, it is not necessary to melt the entire thermoplastic resin in a circumferential direction, and it is only necessary to melt the thermoplastic resin at least in a portion in contact with the surface of the structural body 17.

The optical fiber 1 is conveyed to the molding roller 15 in a state in which the thermoplastic resin on the surface is melted. When the optical fiber 1 is held between the molding roller 15 and the structural body 17, the molten thermoplastic resin and the surface of the structural body 17 come into contact with each other, and the molding roller 15 pressure-bonds the optical fiber 1 to the surface of the structural body 17.

After passing through the heater 14, the thermoplastic resin on the surface of the optical fiber 1 is cooled by contact with the molding roller 15 and the structural body 17, and air cooling. When a temperature of the thermoplastic resin is lowered to a melting point or less after the optical fiber 1 adheres to the surface of the structural body 17, the thermoplastic resin is re-cured. Accordingly, the optical fiber 1 is bonded to the structural body 17 in a state in which the strand is coated with the coating portion made of the thermoplastic resin. It takes one minute or less from pressure-bonding of the optical fiber to re-curing.

By moving the bonding jig 10, melting of the thermoplastic resin, pressure-bonding of the optical fiber, and re-curing of the thermoplastic resin described above are continuously performed.

After bonding the optical fiber 1 to the surface of the structural body 17, the optical fiber 1 is coated by further applying a coating material onto the optical fiber 1. For example, PR1750 (product, name manufactured by PPG Aerospace) is used as the coating material. The coating material has moisture resistance, high temperature resistance, and low temperature resistance. Therefore, good inspection accuracy is ensured in soundness evaluation of the structural body using the optical fiber.

### Second Embodiment

In a bonding jig of a second embodiment, a heater is incorporated in and integrated with a molding roller, and the molding roller is regarded as a component that heats and melts the thermoplastic resin. In this case, the heater in FIG. 2 is omitted. Other components are the same as those of the first embodiment. The bonding jig of the second embodiment has a simpler structure than that of the first embodiment.

In a bonding method and a method for producing a structural body of the second embodiment, by moving the above bonding jig, melting of the thermoplastic resin, pressure-bonding of the optical fiber, and re-curing of the thermoplastic resin are continuously performed.

In the present embodiment, when the optical fiber comes into contact with the molding roller, the thermoplastic resin is heated and melted by the molding roller. A temperature of the molding roller and a moving speed of the bonding jig (that is, a feeding speed of the optical fiber) are adjusted such that the thermoplastic resin located at a bonding surface with the structural body is melted, and the thermoplastic resin coats the strand upon re-cured.

After the optical fiber is bonded to the structural body by the method of the second embodiment, the coating material is applied onto the optical fiber similarly to the first embodiment.

### REFERENCE SIGNS LIST

1 Optical Fiber

2 Strand

3 Coating Portion

10 Bonding Jig

11 Optical fiber Feeding Section

12 Optical Fiber Winding Roller

13 Optical Fiber Feeding Roller

14 Heater

15 Molding Roller (Pressure-Bonding Section)

16 Casing

1. A bonding method for bonding an optical fiber in which a strand is coated with a thermoplastic resin to a surface of a structural body, comprising the steps of:
melting at least one portion of the thermoplastic resin;
bringing the portion where the thermoplastic resin is melted of the optical fiber and the surface into contact with each other in a state in which, the thermoplastic resin is melted;
pressure-bonding the optical fiber to the surface; and cooling and curing the thermoplastic resin.

2. A bonding tool comprising:
an optical fiber feeding section that feeds an optical fiber in which a strand is coated with a thermoplastic resin to a surface of a structural body;
a heater that melts at least one portion of the thermoplastic resin; and
a pressure-bonding section that brings the portion where the thermoplastic resin is melted and the surface into contact with each other, and pressure-bonds the optical fiber to the surface.

3. A method for producing a structural body to which an optical fiber in which a strand is coated with a thermoplastic resin is bonded, comprising the steps of:
melting at least one portion of the thermoplastic resin;
bringing the portion where the thermoplastic resin is melted of the optical fiber and a surface of the structural body into contact with each other in a state in which the thermoplastic resin is melted;
pressure-bonding the optical fiber to the surface; and
cooling and curing the thermoplastic resin.
